(19) United States
(12) Patent Application Publication
(10) Pub. No.: US 2023/0185658 A1
(43) Pub. Date: Jun. 15, 2023

(54) CONFIGURABLE MEMORY PROTECTION LEVELS PER REGION

(71) Applicant: Intel Corporation, Santa Clara, CA (US)

(72) Inventors: Duane Galbi, Wayland, MA (US); Matthew Adiletta, Bolton, MA (US)

(73) Assignee: Intel Corporation, Santa Clara, CA (US)

(21) Appl. No.: 18/108,470

(22) Filed: Feb. 10, 2023

(51) Int. Cl. G06F 11/07; G06F 12/0811

(52) U.S. Cl. CPC G06F 11/0793; G06F 11/073; G06F 12/0811; G06F 2212/601

(57) ABSTRACT

An example of an electronic apparatus may comprise one or more substrates, and a controller coupled to the one or more substrates, the controller including circuitry to control access to a memory for a range of addresses within a memory address space, configure a first region of the memory within a first sub-range of addresses within the memory address space to be accessed with a first protection level of two or more memory fault protection levels, and configure a second region of the memory within a second sub-range of addresses within the memory address space that is non-overlapping with the first sub-range to be accessed with a second protection level of the two or more memory fault protection levels. Other examples are disclosed and claimed.

### BACKGROUND

Reliability, availability and serviceability (RAS), sometimes also referred to as reliability, availability, and maintainability (RAM), refers to computer hardware and software design features that promote robust and fault-tolerant operation for a long uptime for a computer system. With respect to memory, RAS design features may promote data integrity. Example memory RAS features include error correcting codes (ECC), memory sparing, memory mirroring, single device data correction (SDCC), SDDC plus one (SDDC+1), double device data correction (DDDC), adaptive DDDC (ADDDC), and ADDDC plus one (ADDDC+1).

### BRIEF DESCRIPTION OF THE DRAWINGS

The material described herein is illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Further, where considered appropriate, reference labels have been repeated among the figures to indicate corresponding or analogous elements. In the figures:

FIG. 1 is a block diagram of an example of an electronic system according to an example;

FIG. 2 is a block diagram of an example of an electronic apparatus according to an example;

FIGS. 3A to 3B are illustrative diagrams of an example of a method according to an example;

FIGS. 4 to 6 are illustrative diagrams of an example of a memory subsystem according to an example;

FIG. 7 is an illustrative diagram of an example of a computer system according to an example;

FIG. 8 is an illustrative diagram of another example of a computer system according to an example;

FIG. 9 is a block diagram of another example of a computer system according to an example;

FIG. 10 is an illustrative top view of an example of a memory device according to an example; and

FIGS. 11A and 11B are illustrative top and bottom views of another example of a memory device according to an example.

### DETAILED DESCRIPTION

One or more examples or implementations are now described with reference to the enclosed figures. While specific configurations and arrangements are discussed, it should be understood that this is done for illustrative purposes only. Persons skilled in the relevant art will recognize that other configurations and arrangements may be employed without departing from the spirit and scope of the description. It will be apparent to those skilled in the relevant art that techniques and/or arrangements described herein may also be employed in a variety of other systems and applications other than what is described herein.

While the following description sets forth various implementations that may be manifested in architectures such as system-on-a-chip (SoC) architectures for example, implementation of the techniques and/or arrangements described herein are not restricted to particular architectures and/or computing systems and may be implemented by any architecture and/or computing system for similar purposes. For instance, various architectures employing, for example, multiple integrated circuit (IC) chips and/or packages, and/or various computing devices and/or consumer electronic devices such as set top boxes, smartphones, etc., may implement the techniques and/or arrangements described herein. Further, while the following description may set forth numerous specific details such as logic implementations, types and interrelationships of system components, logic partitioning/integration choices, etc., claimed subject matter may be practiced without such specific details. In other instances, some material such as, for example, control structures and full software instruction sequences, may not be shown in detail in order not to obscure the material disclosed herein.

The material disclosed herein may be implemented in hardware, Field Programmable Gate Array (FPGA), firmware, driver, software, or any combination thereof. The material disclosed herein may also be implemented as instructions stored on a machine-readable medium, which may be read and executed by Moore Machine, Mealy Machine, and/or one or more processors. A machine-readable medium may include any medium and/or mechanism for storing or transmitting information in a form readable by a machine (e.g., a computing device). For example, a machine-readable medium may include read only memory (ROM); random access memory (RAM); Dynamic random-access memory (DRAM), magnetic disk storage media; optical storage media; NV memory devices; phase-change memory, qubit solid-state quantum memory, electrical, optical, acoustical or other forms of propagated signals (e.g., carrier waves, infrared signals, digital signals, etc.), and others.

References in the specification to “one implementation”, “an implementation”, “an example implementation”, etc., indicate that the implementation described may include a particular feature, structure, or characteristic, but every example may not necessarily include the particular feature, structure, or characteristic. Moreover, such phrases are not necessarily referring to the same implementation. Further, when a particular feature, structure, or characteristic is described in connection with an example, it is submitted that it is within the knowledge of one skilled in the art to effect such feature, structure, or characteristic in connection with other implementations whether or not explicitly described herein.

Various examples described herein may include a memory component and/or an interface to a memory component. Such memory components may include volatile and/or nonvolatile (NV) memory. Volatile memory may be a storage medium that requires power to maintain the state of data stored by the medium. Non-limiting examples of volatile memory may include various types of RAM, such as DRAM or static RAM (SRAM). One particular type of DRAM that may be used in a memory module is synchronous dynamic RAM (SDRAM). In particular examples, DRAM of a memory component may comply with a standard promulgated by Joint Electron Device Engineering Council (JEDEC), such as JESD79F for double data rate (DDR) SDRAM, JESD79-2F for DDR2 SDRAM, JESD79-3F for DDR3 SDRAM, JESD79-4A for DDR4 SDRAM, JESD209 for Low Power DDR (LPDDR), JESD209-2 for LPDDR2, JESD209-3 for LPDDR3, and JESD209-4 for LPDDR4 (these standards are available at jedec.org). Such standards (and similar standards) may be referred to as DDR-based standards and communication interfaces of the storage devices that implement such standards may be referred to as DDR-based interfaces.

NV memory (NVM) may be a storage medium that does not require power to maintain the state of data stored by the medium. In one example, the memory device may include a three dimensional (3D) crosspoint memory device, or other byte addressable write-in-place nonvolatile memory devices. In one example, the memory device may be or may include memory devices that use chalcogenide glass, single or multi-level Phase Change Memory (PCM), a resistive memory, nanowire memory, ferroelectric transistor RAM (FeTRAM), anti-ferroelectric memory, magnetoresistive RAM (MRAM) memory that incorporates memristor technology, resistive memory including the metal oxide base, the oxygen vacancy base and the conductive bridge RAM (CB-RAM), or spin transfer torque (STT)-MRAM, a spintronic magnetic junction memory based device, a magnetic tunneling junction (MTJ) based device, a DW (Domain Wall) and SOT (Spin Orbit Transfer) based device, a thyristor based memory device, or a combination of any of the above, or other memory. The memory device may refer to the die itself and/or to a packaged memory product. In particular examples, a memory component with non-volatile memory may comply with one or more standards promulgated by the JEDEC, or other suitable standard (the JEDEC standards cited herein are available at jedec.org).

As noted above, reliability, availability and serviceability (RAS), sometimes also referred to as reliability, availability, and maintainability (RAM), refers to computer hardware and software design features that promote robust and fault-tolerant operation for a long uptime for a computer system. With respect to memory, RAS design features may promote data integrity. Example memory RAS features that provide different levels of protections from memory faults include error correcting codes (ECC), memory sparing, memory mirroring, single device data correction (SDCC), SDDC plus one (SDDC+1), double device data correction (DDDC), adaptive DDDC (ADDDC), and ADDDC plus one (ADDDC+1).

RAS expectations for a memory subsystem may include an expectation for a full SDDC capability built into the memory subsystem. Full SDDC capability enables data correction in the event of a full device failure. To enable full SDDC, DRAM devices in a memory subsystem may store bits of ECC data, including ECC trees, in DRAM devices along with the actual data. The ECC data stored in DRAM devices is generally referred to as ECC memory overhead, ECC DRAM or ECC chips. For example, x4 DRAM devices may provide four bytes (“4B”) of data per device using a 4-bit wide data interface and x8 DRAM devices may provide eight bytes (“8B”) of data per device using an 8-bit wide data interface.

Processor cores may operate with fixed-size cache lines, such as a 64 byte (“64B”) cache line size. The processor's DRAM memory subsystem typically operates on a matching 64B cache line size and includes the ECC data to enable SDDC for the memory subsystem. For a memory subsystem built with x4 DRAMs that have a burst length of sixteen (16), such as DRAMS that operate in accordance with the DDR version 5 (DDR5), the memory interface requires eight (8) DRAMs for the 64B cache data and an extra two (2) DRAMs to supply the SDDC ECC data used to error check and correct the data. As a result, an extra 25% of DRAMs, two (2) per eight (8) DRAMS, are required to enable SDDC.

Other memory devices may have a much smaller ratio of data signal lines per device to the total number of bits per read operation (e.g., sometimes referred to as shrinking channels), as more data is provided from fewer devices. Additionally, ECC bits allocated to ECC data in a DRAM are sometimes repurposed for poisoning, directories, security, or other applications. It is unlikely that future generations of memory devices will have enough ECC bits available in the ECC memory overhead to provide full SDDC capability

Different customers and/or different applications may have a variety of requirements needed and/or requested by such customers and/or applications. Various tradeoffs may be involved between performance, capacity, reliability, etc. for such customers and/or applications. For example, some customers or applications may need or request a true, full chip-fail level of memory fault protection (e.g., sometimes referred to as chip-kill). To meet such requests, a cloud service provider may build an x4 DRAM memory system to provide an acceptable full chip-fail solution for a 64-byte system cache line size. A problem is that, as DRAM memory chips move to wider data input/output (IO) (e.g., x4 to x8, etc., in width), full chip-fail RAS protection is relatively expensive.

On the other hand, some customers or applications may need or request other levels of memory fault protection (e.g., bounded fault (sometimes also referred to as bounded failure), on-chip ECC, etc.). Bounded fault technology may limit fault propagation to within a certain set of data IOs such that a wide IO chip may act like more than one fault region and hence lower the cost of an approximate fault region for a chip-fail RAS solution. To meet such requests, a cloud service provider may build an x8 DRAM memory system with wider DRAM that can utilize bounded fault RAS solutions to provide an approximate full chip-fail (e.g., a fault region kill) at lower cost. A problem is that building different systems to accommodate the different levels of protection needed or requested by different customers or applications increases the complexity and costs due to having to provide and maintain multiple systems.

Some examples may overcome one or more of the foregoing problems. In some implementations, a platform may employ technology for configurable memory protection levels on a per memory region basis. In some examples, a single memory type (e.g., DRAM) may support multiple RAS regions. For example, main memory (e.g., system memory or another contiguous range of the same memory type) may support an arrangement with different RAS levels for different regions of the main memory. Advantageously, some examples may provide more control and flexibility for configuration of RAS regions for lower latency and/or the lowest latency memory devices in a system.

Some examples may provide an external memory subsystem that has run time configurable sized regions of different external memory RAS protection. The size of the different external memory RAS regions may be configured using any suitable techniques (e.g., pages tables, range registers, etc.). The protection level of the different memory regions may be configured using any suitable technology. In some examples, the RAS of the external memory may be modified by changing the external memory subsystem cache line size or by other techniques to spread the cache line across more external memory fault regions.

In some implementations, increasing the cache line size may reduce the RAS overhead. In an x4 system, for example, a 64B cache line may utilize an eight plus two (8+2) DRAM arrangement with twenty five percent (25%) RAS overhead while a 128B cache line may utilize a sixteen plus two (16+2) DRAM arrangement with twelve and a half percent (12.5%) RAS overhead. In an x8 system, for example, a 64B cache line may utilize a four plus 2 (4+2) DRAM arrangement with fifty (50%) RAS overhead, while a 128B cache line may utilize an eight plus two (8+2) DRAM arrangement with twenty five percent (25%) RAS overhead, and/or while a 256B cache line may utilize a sixteen plus two (16+2) DRAM arrangement with twelve and a half percent (12.5%) RAS overhead.

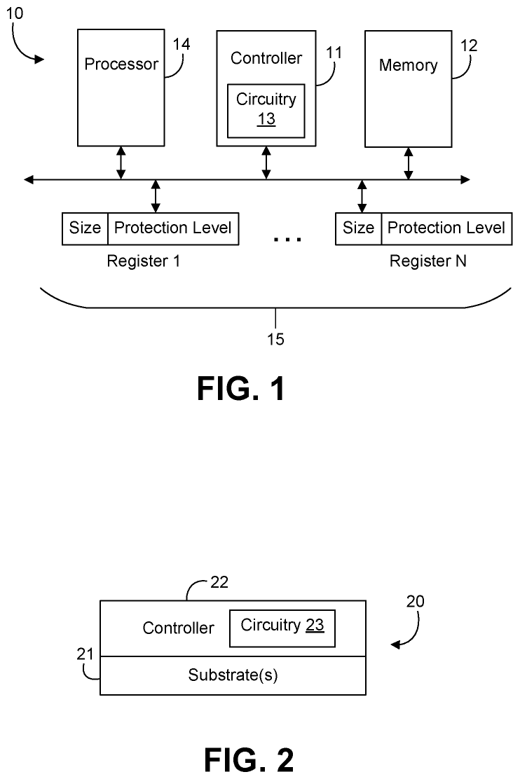

With reference to FIG. 1, an example of an electronic system 10 may include memory 12 (e.g., local memory, remote memory, pooled memory, remote pooled memory, tier memory, two level memory (2LM), etc.) and a controller 11 communicatively coupled to the memory 12. The controller 11 may include circuitry 13 to control access to the memory 12 for a range of addresses within a memory address space (e.g., a full range of addresses within a system memory address space, a full range of addresses within a full memory address space, etc.), and configure respective regions (e.g., of memory of the same type) of the memory 12 with respective non-overlapping sub-ranges of addresses within the memory address space to be accessed with a protection level of two or more memory fault protection levels respectively associated with the respective regions of the memory 12. In some examples, the circuitry 13 may reconfigure one or more of the respective regions of the memory 12 at runtime in response to a request from a software agent (e.g., an operating system (OS), a hypervisor, an application, etc.). Those skilled in the art will appreciate that the address ranges and protection levels for different memory regions may be changed at runtime on numerous occasions over time in response to further requests from the software agent (e.g., due to changed performance needs, changed operating conditions, etc.).

In some examples, the circuitry 13 may be further configured to determine a protection level associated with a region of the memory 12 based on information to be stored in a data structure that is accessible to the controller. In some examples, the circuitry 13 may be configured to access the data structure from one or more page tables (e.g., where the page tables are to be stored in the memory 12). Alternatively, or additionally, the circuitry 13 may be configured to configured to access the data structure from one or more registers. For example, the circuitry 13 may also be configured to provide information to the software agent (e.g., an OS, a hypervisor, application, etc.). In some examples, the circuitry 13 may be further configured to interleave respective regions of the memory with respective memory fault protection levels (e.g., in accordance with the information stored in the data structure).

In some examples, the circuitry 13 may be further configured to configure respective cache line sizes for the respective regions of memory in accordance with the respective associated protection levels (e.g., as described in further detail herein). In some examples, the memory 12 may correspond to an external memory subsystem, and/or a first protection level of the two or more memory fault protection levels corresponds to a full chip-fail level of memory fault protection and a second protection level of the two or more memory fault protection levels may correspond to a bounded fault level of memory fault protection. Some examples of the system 10 may further include a processor 14 communicatively coupled to the memory 12. For example, the processor 14 may be natively coupled to the memory 12, communicatively coupled to the memory 12 via a cache-coherent interconnect (e.g., such as Compute Express Link (CXL)), etc.

In some examples, a set of N registers 15 (N>1) each include fields that indicate a size of a memory region and a RAS protection level associated with that region. The registers 15 may include additional or other fields (e.g., a unique identifier, an address range, etc.). For example, the registers 15 may be configuration registers, model specific registers (MSRs), range registers, etc. Suitably privileged software (e.g., executed by the processor 14) may write appropriate values into the fields of the registers 15. The controller 11, circuitry 13, and other components of the system 10 (e.g., hardware, firmware, software, etc.) access the registers 15 as needed to read the stored values to support operations involving the memory 12.

Examples of the controller 11 may include a general purpose controller, a special purpose controller, a memory controller, a storage controller, a micro-controller, an execution unit, etc. In some examples, the memory 12, the circuitry 13, and/or other system memory may be located in, or co-located with, various components, including the controller 11 (e.g., on a same die or package substrate). For example, the controller 11 may be configured as a memory controller and the memory 12 may be a connected memory device such as DRAM, NVM, a solid-state drive (SSD), a storage node, etc. Examples of each of the above controller 11, memory 12, circuitry 13, and other system components may be implemented in hardware, software, or any suitable combination thereof. For example, hardware implementations may include configurable logic, fixed-functionality logic, or any combination thereof. Examples of configurable logic include suitably configured programmable logic arrays (PLAs), FPGAs, complex programmable logic devices (CPLDs), and general purpose microprocessors. Examples of fixed-functionality logic include suitably configured application specific integrated circuits (ASICs), combinational logic circuits, and sequential logic circuits. The configurable or fixed-functionality logic can be implemented with complementary metal oxide semiconductor (CMOS) logic circuits, transistor-transistor logic (TTL) logic circuits, or other circuits.

Alternatively, or additionally, all or portions of these components may be implemented in one or more modules as a set of logic instructions stored in a machine- or computer-readable storage medium such as RAM, ROM, programmable ROM (PROM), firmware, etc., to be executed by a processor or computing device. For example, computer program code to carry out the operations of the components may be written in any combination of one or more operating system (OS) applicable/appropriate programming languages, including an object-oriented programming language such as PYTHON, PERL, JAVA, SMALLTALK, C++, C#, VHDL, Verilog, System C or the like and conventional procedural programming languages, such as the “C” programming language or similar programming languages. For example, the memory 12, persistent storage media, or other system memory may store a set of instructions (e.g., which may be firmware instructions) which when executed by the controller 11 (e.g., or the processor 14) cause the system 10 to implement one or more components, features, or aspects of the system 10 (e.g., controlling access to the memory 12, configuring the respective regions of the memory 12 with respective protection levels, reconfiguring the respective regions of the memory 12 with indicated protection levels at runtime, etc.).

With reference to FIG. 2, an example of an electronic apparatus 20 may include one or more substrates 21, and a controller 22 coupled to the one or more substrates 21. The controller 22 may include circuitry 23 to control access to a memory for a range of addresses within a memory address space, configure a first region of the memory within a first sub-range of addresses within the memory address space to be accessed with a first protection level of two or more memory fault protection levels, and configure a second region of the memory (e.g., of the same memory type as the first region) within a second sub-range of addresses within the memory address space that is non-overlapping with the first sub-range to be accessed with a second protection level of the two or more memory fault protection levels. In some examples, the circuitry 23 may also reconfigure one or more of the first and second regions of the memory with a different sub-range of addresses at runtime in response to a request from a software agent, and/or to reconfigure one or more of the first and second regions of the memory with a different memory fault protection level at runtime in response to a request from the software agent.

In some examples, the circuitry 23 may be further configured to determine respective protection levels associated with respective regions of the memory (e.g., of the same memory type) based on information to be stored in a data structure that is accessible to the controller. For example, the circuitry 23 may be configured to access the data structure from one or more page tables to be stored in the memory, and/or to access the data structure from one or more registers. In some examples, the circuitry 23 may be further configured to interleave respective regions of the memory with respective memory fault protection levels (e.g., in accordance with the information stored in the data structure).

The circuitry 23 may also be configured to configure respective cache line sizes for the first and second regions of memory in accordance with the respective first and second protection levels. In some examples, the memory may correspond to an external memory subsystem, the first protection level may correspond to a full chip-fail level of memory fault protection and the second protection level may correspond to a bounded fault level of memory fault protection, and/or the memory may be natively coupled to a processor, communicatively coupled to a processor via a cache-coherent interconnect, etc.

For example, the controller 22 may be configured as a memory controller. For example, the memory may be a connected memory device (e.g., DRAM, NVM, SSD, a storage node, etc.). Examples of the circuitry 23 may be implemented in a system, apparatus, computer, device, etc., for example, such as those described herein. More particularly, hardware implementations may include configurable logic (e.g., suitably configured PLAs, FPGAs, CPLDs, general purpose microprocessors, etc.), fixed-functionality logic (e.g., suitably configured ASICs, combinational logic circuits, sequential logic circuits, etc.), or any combination thereof. Alternatively, or additionally, the circuitry 23 may be implemented in one or more modules as a set of logic instructions stored in a machine- or computer-readable storage medium such as RAM, ROM, PROM, firmware, etc., to be executed by a processor or computing device. For example, computer program code to carry out the operations of the components may be written in any combination of one or more OS applicable/appropriate programming languages, including an object-oriented programming language such as PYTHON, PERL, JAVA, SMALLTALK, C++, C#, VHDL, Verilog, System C or the like and conventional procedural programming languages, such as the “C” programming language or similar programming languages.

For example, the circuitry 23 may be implemented on a semiconductor apparatus, which may include the one or more substrates 21, with the circuitry 23 coupled to the one or more substrates 21. In some examples, the circuitry 23 may be at least partly implemented in one or more of configurable logic and fixed-functionality hardware logic on semiconductor substrate(s) (e.g., silicon, sapphire, gallium-arsenide, etc.). For example, the circuitry 23 may include a transistor array and/or other integrated circuit components coupled to the substrate(s) 21 with transistor channel regions that are positioned within the substrate(s) 21. The interface between the circuitry 23 and the substrate(s) 21 may not be an abrupt junction. The circuitry 23 may also be considered to include an epitaxial layer that is grown on an initial wafer of the substrate(s) 21.

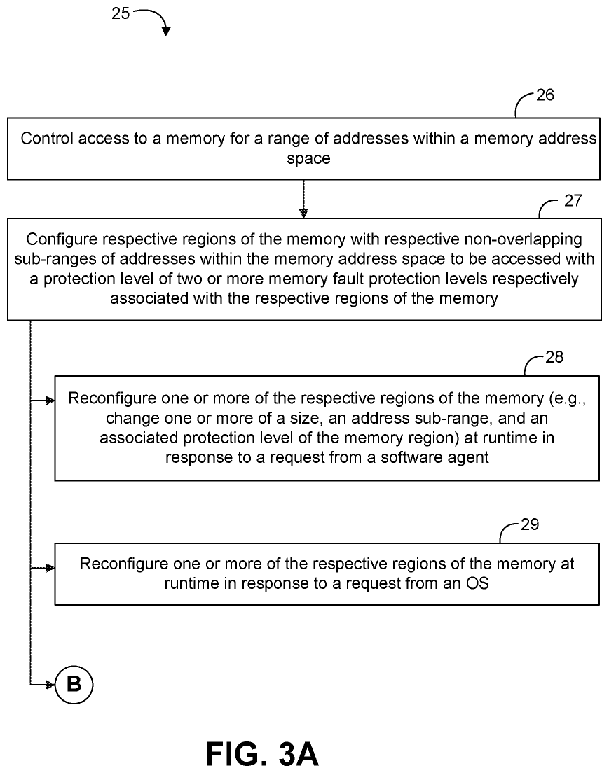

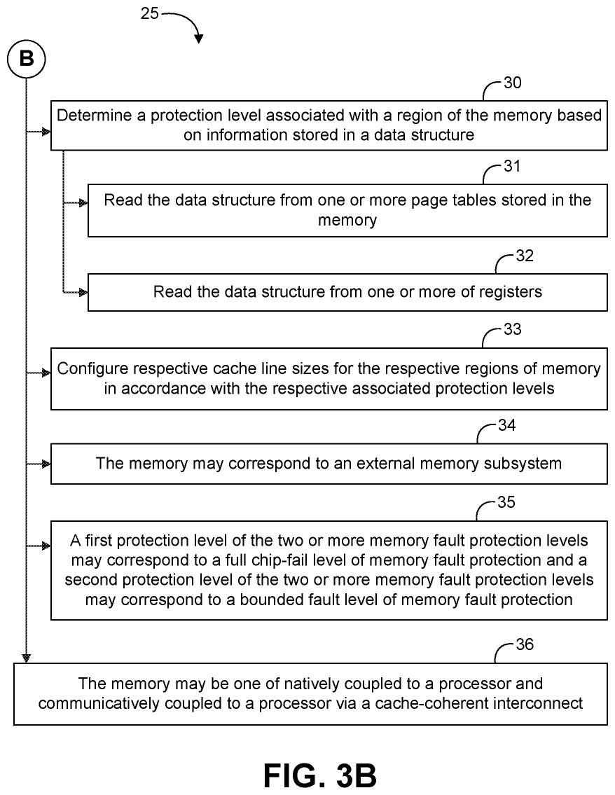

Turning now to FIGS. 3A to 3B, an example of a method 25 may include controlling access to a memory for a range of addresses within a memory address space at block 26, and configuring respective regions of the memory (e.g., of the same memory type) with respective non-overlapping sub-ranges of addresses within the memory address space to be accessed with a protection level of two or more memory fault protection levels respectively associated with the respective regions of the memory at block 27. For example, the method 25 may include reconfiguring one or more of the respective regions of the memory (e.g., changing one or more of a size, an address sub-range, and an associated protection level of the memory region) at runtime in response to a request from a software agent at block 28, and/or reconfiguring one or more of the respective regions of the memory at runtime in response to a request from an OS at block 29.

In some examples, the method 25 may further include determining a protection level associated with a region of the memory based on information stored in a data structure at block 30. For example, the method 25 may include reading the data structure from one or more page tables stored in the memory at block 31, and/or reading the data structure from one or more of registers at block 32. The method 25 may also include configuring respective cache line sizes for the respective regions of memory in accordance with the respective associated protection levels at block 33. In some examples, the memory may correspond to an external memory subsystem at block 34, a first protection level of the two or more memory fault protection levels may correspond to a full chip-fail level of memory fault protection and a second protection level of the two or more memory fault protection levels may correspond to a bounded fault level of memory fault protection at block 35, and/or the memory may be one of natively coupled to a processor and communicatively coupled to a processor via a cache-coherent interconnect at block 36.

Examples of the method 25 may be implemented in a system, apparatus, computer, device, etc., for example, such as those described herein. More particularly, hardware implementations may include configurable logic (e.g., suitably configured PLAs, FPGAs, CPLDs, general purpose microprocessors, etc.), fixed-functionality logic (e.g., suitably configured ASICs, combinational logic circuits, sequential logic circuits, etc.), or any combination thereof. Hybrid hardware implementations include static dynamic System-on-Chip (SoC) re-configurable devices such that control flow, and data paths implement logic for the functionality. Alternatively, or additionally, the method 25 may be implemented in one or more modules as a set of logic instructions stored in a machine- or computer-readable storage medium such as RAM, ROM, PROM, firmware, etc., to be executed by a processor or computing device. For example, computer program code to carry out the operations of the components may be written in any combination of one or more OS applicable/appropriate programming languages, including an object-oriented programming language such as PYTHON, PERL, JAVA, SMALLTALK, C++, C#, VHDL, Verilog, System C or the like and conventional procedural programming languages, such as the “C” programming language or similar programming languages.

For example, the method 25 may be implemented on a computer readable medium. Examples or portions of the method 25 may be implemented in firmware, applications (e.g., through an application programming interface (API)), or driver software running on an OS. Additionally, logic instructions might include assembler instructions, instruction set architecture (ISA) instructions, data set architecture (DSA) commands, (machine instructions, machine dependent instructions, microcode, state-setting data, configuration data for integrated circuitry, state information that personalizes electronic circuitry and/or other structural components that are native to hardware (e.g., host processor, central processing unit (CPU), microcontroller, Moore Machine, Mealy Machine, etc.).

Some examples may provide technology for a CPU supporting regions of memory with different levels of memory RAS protection. Any suitable technology may be utilized to provide different RAS protection levels for different memory regions. For example, some memory subsystems may be configured to support multiple external memory cache line sizes while keeping the internal processor cache line size unchanged (e.g., at 64 bytes). In another example, some memory subsystems may be configured to create different levels of RAS with a remapping scheme to pack different effective cache line sizes into memory. Those skilled in the art will appreciate that other approaches may also be utilized to provide different levels of RAS protection.

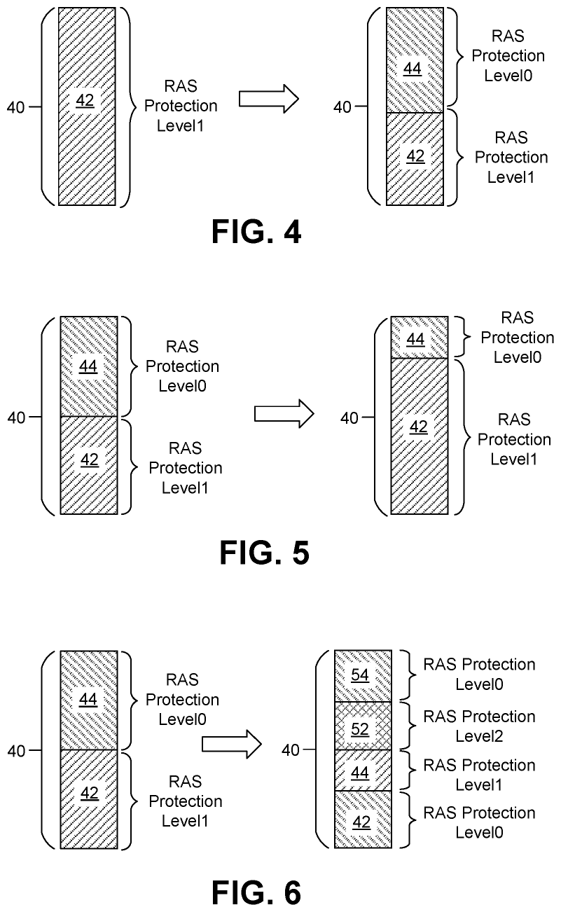

FIGS. 4 to 6 show different examples of how a memory subsystem 40 (e.g., an external memory subsystem) may be configured or reconfigured with different RAS protection levels for different memory regions. In the illustrated examples, three protection levels may be nominally referred to as RAS Protection Level0 (e.g., full chip-kill, 128 byte cache line), RAS Protection Level1 (e.g., bounded fault, 64 byte cache line), and RAS Protection Level2 (e.g., on-chip ECC, 64 byte cache line). Other examples may include more or fewer protection levels. In the illustrated examples, the overall rectangle represents the memory address space, while the different hatch patterns represent different RAS protection regions.

In FIG. 4, the memory subsystem 40 starts with RAS Protection Level1 for a first memory region 42 for the memory address space. The memory subsystem 40 is subsequently reconfigured (e.g., at runtime) with two memory regions with and RAS Protection Level1 for a reduced size first memory region 42 (e.g., about 50% of the memory address space) RAS Protection Level0 for a second memory region 44 (e.g., the remainder of the memory address space).

FIG. 5 shows an example of how a size of the RAS protection regions are dynamically adjustable. The memory subsystem 40 starts with the two memory regions with RAS Protection Level1 for the first memory region 42 and RAS Protection Level0 for the second memory region 44. The memory subsystem 40 is subsequently reconfigured (e.g., at runtime) with a larger size (e.g., greater than 50% of the memory address space) for the first memory region 42 with RAS Protection Level1 and a smaller size (e.g., the remainder of the memory address space) for the second memory region 44 with RAS Protection Level1. For example, the respective region sizes may be adjusted based on application demand.

FIG. 6 shows an example of interleaving of different protection regions. The memory subsystem 40 starts with the two memory regions with RAS Protection Level1 for the first memory region 42 and RAS Protection Level0 for the second memory region 44. The memory subsystem 40 is subsequently reconfigured (e.g., at runtime) with a smaller size for the first memory region 42 with RAS Protection Level1, a smaller size for the second memory region 44 with RAS Protection Level1, a third memory region 52 with RAS Protection Level2, and a fourth memory region 54 with RAS Protection Level0. For example, the region interleaving may be based on application demand.

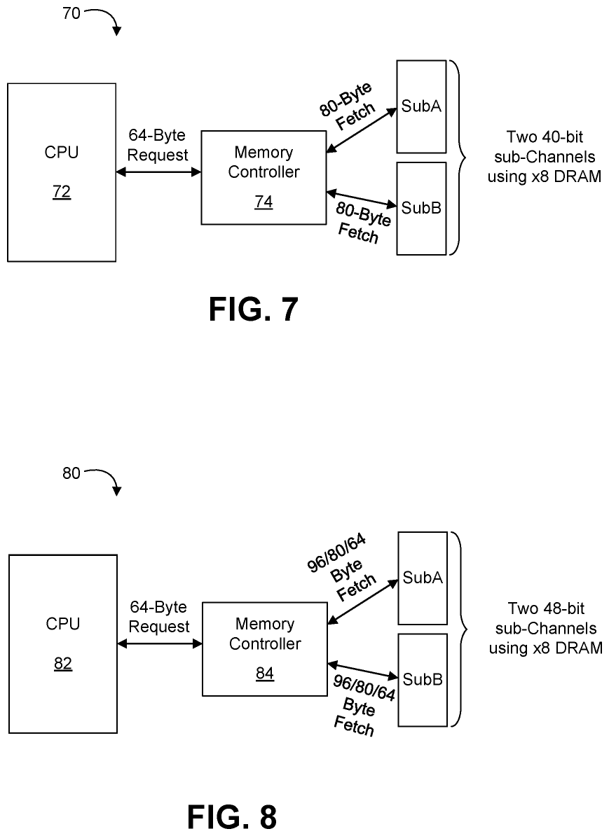

FIG. 7 shows an example of a computer system 70 that includes a CPU 72 coupled to a multi-channel memory controller 74. The memory controller 74 may control access to a memory subsystem via two sub-channels (nominally labeled “SubA” and “SubB”). The system 70 may be configured to provide different RAS regions by varying an external cache line size.

For example, the system 70 may support an increased cache line size of 128 bytes (e.g., increased from 64 bytes). The increased cache line size allows a true chip-fail RAS solution to be implemented with x8 DRAM. In some examples, suitable technology is utilized to keep the internal CPU line size at 64 bytes while the external DRAM line size is increased to 128 bytes. The RAS protection level for the DRAM may be based on 128 bytes, while the processor internals remain at the 64-byte cache line size. For example, the increased cache line size allows the highest level of chip-fail RAS support to be implemented using x8 DRAM. However, the larger external memory subsystem cache line size utilized may be detrimental to performance for some applications. Advantageously, some examples allow the customer or application to configure the memory with different RAS protection levels for different memory regions.

In some examples, the system 70 may be built with an external memory subsystem of x8 wide DRAM. In cases where bounded fault RAS is sufficient, the customers and/or applications are configured to operate in memory regions where the external memory subsystem operates in a 64-byte cache line with bounded fault RAS. Those applications or customers that request true chip-fail RAS protection are configured to operate in memory regions when the external memory subsystem operates in a 128-byte cache line size. In 128-byte mode, the extra data read may be cached in the memory controller 74 or the L2/L3 cache(s) of the CPU 72. Writes are paired using the L2/L3 cache(s) of the CPU 72 or extra buffering in the memory controller 74. The memory controller reads from both sub-channels to build a 128-byte cache line, or from a single sub-channel for a 64-byte cache line.

FIG. 8 shows an example of a computer system 80 that includes a CPU 82 coupled to a multi-channel memory controller 84. The memory controller 84 may control access to a memory subsystem (e.g., external DRAM) via two sub-channels (nominally labeled “SubA” and “SubB”). The system 80 may be configured to provide different RAS regions by varying an amount of data fetched per sub-channel read. For example, the full amount of memory required for full chip-fail RAS using 64-byte external cache lines may be provisioned. For regions of lower RAS, the raw 64-byte cache line size is smaller, and more cache lines may be mapped into the external address space required for full chip-fail RAS. For example, an x8 DRAM and 64-byte cache lines may involve 50% overhead for full chip-fail RAS protection, 25% overhead for bounded fault RAS protection, and 0% overhead for on-chip ECC RAS protection. For the system 80, the different raw cache line sizes may be mapped into the space allocated for the full 50% overhead required for full chip-fail. For higher levels of RAS, the memory controller 84 fetches more bytes per 64-byte request. Lower levels of RAS allow more memory lines to fit in the memory subsystem.

In some examples, some of the remapping logic may be included directly in the DRAM to reduce or eliminate the need for any additional DIMM pins. In some examples, the use of a LPDRAM stack, instead of DIMM, may allow for more control over the individual DRAM chips. For example, in cases where a LPDRAM stack is used, the remapping may be implemented to directly control the individual LPDRAM address pins and may not require any change to the LPDRAM chip. In some examples, technology to vary the external cache line size and technology to vary the amount of data fetched per sub-channel read may be combined to create addition levels of external memory RAS protection.

Advantageously, some examples allow a cloud service provider to build one type of system, using x8 wide DRAM, and to provide two or more types of memory regions (e.g., corresponding to two or more types of RAS protection: true chip-fail RAS, bounded-fault chip-fail RAS, etc.) with that one type of system. The cloud service provider may dynamically change the allocation between these two types of regions and match different levels RAS protection to different levels of service requested by a customer or application (e.g., at different price levels). Applications can also potentially choose to segment their storage into classes requiring high RAS protection and classes requiring lower RAS protection. The classes can then be mapped to the different memory RAS protection regions to reduce the external memory cost of their application(s).

As more functionality, capability, and resources are packed into a platform (e.g., including higher thermal design power (TDP), more channels, larger DIMMs, memory hierarchy, etc.), the platform may benefit from more advanced RAS capabilities in order to provide more flexibility to handle errors that come up. CXL type 2 and type 3 devices may include local memory or may provide memory expansion boards and storage-class memory that may use the CXL.memory protocol. As such CXL device types become more utilized in the industry, DRAM errors may be more prevalent and improved RAS schemes may be needed.

Non-limiting examples of edge components/applications that may benefit from examples described herein include base stations, control delivery networks, small cells, on-premise equipment or cloudlets, cell towers, and micro-datacenters.

Some examples provide technology to employ dynamically configurable RAS protection regions in native attach memory and CXL memory. In a datacenter scenario where servers are expected to run 24×7, some example may advantageously improve server availability. In some examples, memory (e.g., local memory, remote memory, pooled memory, remote pooled memory, etc.) may be part of a composable server (e.g., a server that utilizes composable disaggregated infrastructure (CDI) with management software, sometimes referred to as an orchestrator or a composer, or otherwise makes use of high-bandwidth, low-latency interconnects to aggregate compute, storage, and networking fabric resources into shared resource pools that can be available for on-demand allocation) and/or an dynamically configurable RAS protection region scheme may be implemented at least in part by the orchestrator/composer.

The technology discussed herein may be provided in various computing systems (e.g., including a non-mobile computing device such as a desktop, workstation, server, rack system, etc., a mobile computing device such as a smartphone, tablet, Ultra-Mobile Personal Computer (UMPC), laptop computer, ULTRABOOK computing device, smart watch, smart glasses, smart bracelet, etc., and/or a client/edge device such as an Internet-of-Things (IoT) device (e.g., a sensor, a camera, etc.)).

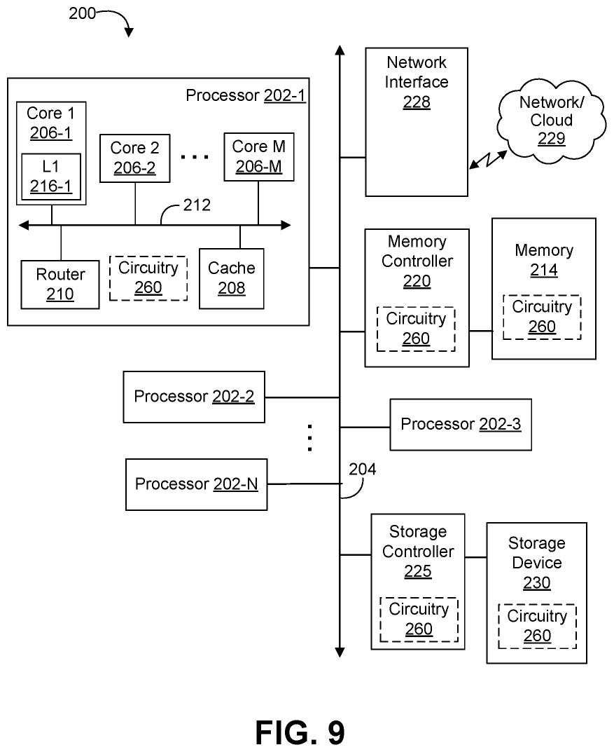

Turning now to FIG. 9, an example of a computer system 200 may include one or more processors 202-1 through 202-N (generally referred to herein as “processors 202” or “processor 202”). The processors 202 may communicate via an interconnection or bus 204. Each processor 202 may include various components some of which are only discussed with reference to processor 202-1 for clarity. Accordingly, each of the remaining processors 202-2 through 202-N may include the same or similar components discussed with reference to the processor 202-1.

In some examples, the processor 202-1 may include one or more processor cores 206-1 through 206-M (referred to herein as “cores 206,” or more generally as “core 206”), a cache 208 (which may be a shared cache or a private cache in various examples), and/or a router 210. The processor cores 206 may be implemented on a single integrated circuit (IC) chip. Moreover, the chip may include one or more shared and/or private caches (such as cache 208), buses or interconnections (such as a bus or interconnection 212), memory controllers, or other components.

In some examples, the router 210 may be used to communicate between various components of the processor 202-1 and/or system 200. Moreover, the processor 202-1 may include more than one router 210. Furthermore, the multitude of routers 210 may be in communication to enable data routing between various components inside or outside of the processor 202-1.

The cache 208 may store data (e.g., including instructions) that is utilized by one or more components of the processor 202-1, such as the cores 206. For example, the cache 208 may locally cache data stored in a memory 214 for faster access by the components of the processor 202. As shown in FIG. 9, the memory 214 may be in communication with the processors 202 via the interconnection 204. In some examples, the cache 208 (that may be shared) may have various levels, for example, the cache 208 may be a mid-level cache and/or a last-level cache (LLC). Also, each of the cores 206 may include a level 1 (L1) cache (216-1) (generally referred to herein as “L1 cache 216”). Various components of the processor 202-1 may communicate with the cache 208 directly, through a bus (e.g., the bus 212), and/or a memory controller or hub.

As shown in FIG. 9, memory 214 may be coupled to other components of system 200 through a memory controller 220. Memory 214 may include volatile memory and may be interchangeably referred to as main memory or system memory. Even though the memory controller 220 is shown to be coupled between the interconnection 204 and the memory 214, the memory controller 220 may be located elsewhere in system 200. For example, memory controller 220 or portions of it may be provided within one of the processors 202 in some examples. Alternatively, memory 214 may include byte-addressable non-volatile memory such as INTEL OPTANE technology.

The system 200 may communicate with other devices/systems/networks via a network interface 228 (e.g., which is in communication with a computer network and/or the cloud 229 via a wired or wireless interface). For example, the network interface 228 may include an antenna (not shown) to wirelessly (e.g., via an Institute of Electrical and Electronics Engineers (IEEE) 802.11 interface (including IEEE 802.11a/b/g/n/ac, etc.), cellular interface, 3G, 4G, LTE, BLUETOOTH, etc.) communicate with the network/cloud 229.

System 200 may also include a storage device such as a storage device 230 coupled to the interconnect 204 via storage controller 225. Hence, storage controller 225 may control access by various components of system 200 to the storage device 230. Furthermore, even though storage controller 225 is shown to be directly coupled to the interconnection 204 in FIG. 9, storage controller 225 can alternatively communicate via a storage bus/interconnect (such as the SATA (Serial Advanced Technology Attachment) bus, Peripheral Component Interconnect (PCI) (or PCI EXPRESS (PCIe) interface), NVM EXPRESS (NVMe), Serial Attached SCSI (SAS), Fiber Channel, CXL, etc.) with one or more other components of system 200 (for example where the storage bus is coupled to interconnect 204 via some other logic like a bus bridge, chipset, etc.) Additionally, storage controller 225 may be incorporated into memory controller logic or provided on a same integrated circuit (IC) device in various examples (e.g., on the same circuit board device as the storage device 230 or in the same enclosure as the storage device 230).

Furthermore, storage controller 225 and/or storage device 230 may be coupled to one or more sensors (not shown) to receive information (e.g., in the form of one or more bits or signals) to indicate the status of or values detected by the one or more sensors. These sensor(s) may be provided proximate to components of system 200 (or other computing systems discussed herein), including the cores 206, interconnections 204 or 212, components outside of the processor 202, storage device 230, SSD bus, SATA bus, storage controller 225, circuitry 260, etc., to sense variations in various factors affecting power/thermal behavior of the system/platform, such as temperature, operating frequency, operating voltage, power consumption, and/or inter-core communication activity, etc.

As shown in FIG. 9, features or aspects of the circuitry 260 may be distributed throughout the system 200, and/or co-located/integrated with various components of the system 200. Any aspect of the system 200 that may require or benefit from configurable RAS protection region technology may include the circuitry 260. For example, the memory controller 220 and the storage controller 225 may each include circuitry 260, which may be in the same enclosure as the system 200 and/or fully integrated on a printed circuit board (PCB) of the system 200. For example, the circuitry 260 may be configured to implement the configurable RAS protection region features of the various examples. For example, the respective circuitry 260 may be configured to provide configurable RAS protection region technology for the memory 214 and/or the storage device 230. The processors 202 may include circuitry 260 to implement the host/OS/agent aspects of the various examples described herein.

Advantageously, the circuitry 260 may include technology to implement one or more aspects of the system 10 (FIG. 1), the apparatus 20 (FIG. 2), the method 25 (FIGS. 3A to 3B), the memory subsystem 40 (FIGS. 4 to 6), the system 70 (FIG. 7), the system 80 (FIG. 8), and/or any of the configurable RAS protection region features discussed herein. The system 200 may include further circuitry 260 and located outside of the foregoing components.

In some examples, the circuitry 260 may be configured to control access to the memory 214 for a range of addresses within a memory address space, and configure respective regions of the memory 214 with respective non-overlapping sub-ranges of addresses within the memory address space to be accessed with a protection level of two or more memory fault protection levels respectively associated with the respective regions of the memory. In some examples, the circuitry 260 may reconfigure one or more of the respective regions of the memory 214 at runtime in response to a request from a software agent (e.g., an operating system (OS), a hypervisor, an application, etc.). Those skilled in the art will appreciate that the address ranges and protection levels for different memory regions may be changed at runtime on numerous occasions over time in response to further requests from the software agent (e.g., due to changed performance needs, changed operating conditions, etc.).

In some examples, the circuitry 260 may be further configured to determine a protection level associated with a region of the memory 214 based on information to be stored in a data structure that is accessible to the controller. In some examples, the circuitry 260 may be configured to access the data structure from one or more page tables (e.g., where the page tables are to be stored in the memory 214). Alternatively, or additionally, the circuitry 260 may be configured to configured to access the data structure from one or more registers. For example, the circuitry 260 may also be configured to provide information to the software agent (e.g., an OS, a hypervisor, application, etc.).

In some examples, the circuitry 260 may be further configured to configure respective cache line sizes for the respective regions of memory in accordance with the respective associated protection levels (e.g., as described in further detail herein). In some examples, the memory 214 may correspond to an external memory subsystem, and/or a first protection level of the two or more memory fault protection levels corresponds to a full chip-fail level of memory fault protection and a second protection level of the two or more memory fault protection levels may correspond to a bounded fault level of memory fault protection. For example, the processor 202 may be natively coupled to the memory 214, communicatively coupled to the memory 214 via a cache-coherent interconnect (e.g., such as CXL), etc.

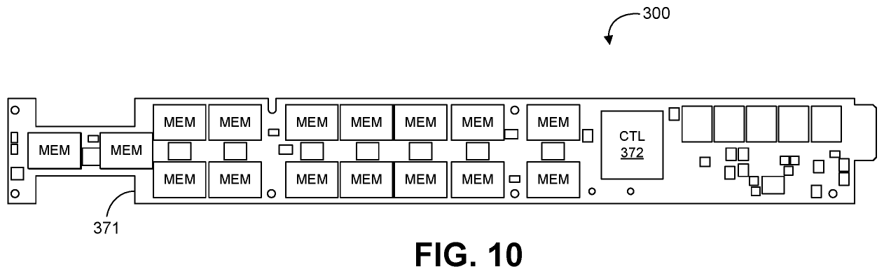

With reference to FIG. 10, an example of a memory device 300 includes a PCB 371 with an E1.L standard form factor. The memory device 300 may be configured for performance clustered, bandwidth-optimized storage. FIG. 10 shows only one side of the memory device 300, with an example of 16 packages of memory ICs per side for a total of 32 memory ICs. In other examples, the number of packages/ICs may vary based on the configuration. The memory device 300 further includes a controller 372. The controller 372 may be configured to provide configurable RAS protection region features as described herein.

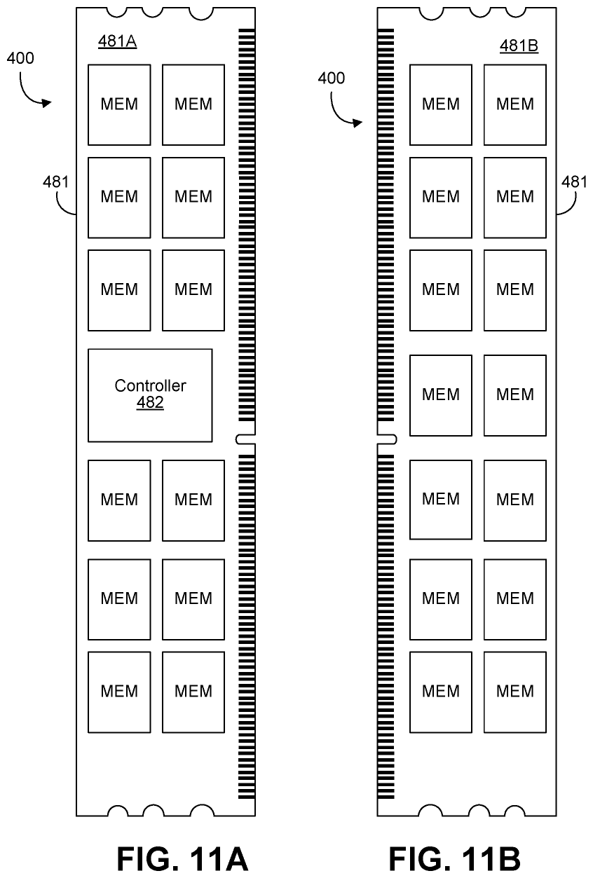

With reference to FIGS. 11A and 11B, an example of a memory device 400 may include a PCB 481 with a DIMM form factor, including pins along both sides of a connector edge and components on both sides 481A and 481B of the DIMM. The number of pins shown in FIGS. 11A and 11B is for illustration purposes only, and more or fewer pins may be provided in various examples. The particular DIMM form factor shown in FIGS. 11A and 11B is for illustration purposes only, and other DIMM form factors may be provided in various examples. The memory device 400 may include additional components, circuitry, and logic to operate as a CXL standards compliant type 2 or type 3 device. For example, the memory device 400 may include, among other things, a controller 482 mounted on the PCB 481, interface component(s) including a communication interface, and a plurality of memory ICs mounted on the PCB 481. In accordance with some examples, the controller 482 may be configured to provide configurable RAS protection region features as described herein.

### Additional Notes and Examples

Example 1 includes an electronic apparatus, comprising one or more substrates, and a controller coupled to the one or more substrates, the controller including circuitry to control access to a memory for a range of addresses within a memory address space, configure a first region of the memory within a first sub-range of addresses within the memory address space to be accessed with a first protection level of two or more memory fault protection levels, and configure a second region of the memory within a second sub-range of addresses within the memory address space that is non-overlapping with the first sub-range to be accessed with a second protection level of the two or more memory fault protection levels (e.g., where the first region and the second region correspond to a same memory type, such as DRAM).

Example 2 includes the apparatus of Example 1, wherein the circuitry is further to reconfigure one or more of the first and second regions of the memory with a different sub-range of addresses at runtime in response to a request from a software agent.

Example 3 includes the apparatus of any of Examples 1 to 2, wherein the circuitry is further to reconfigure one or more of the first and second regions of the memory with a different memory fault protection level at runtime in response to a request from a software agent.

Example 4 includes the apparatus of any of Examples 1 to 3, wherein the circuitry is further to determine respective protection levels associated with respective regions of the memory based on information to be stored in a data structure that is accessible to the controller.

Example 5 includes the apparatus of Example 4, wherein the circuitry is further to access the data structure from one or more page tables to be stored in the memory.

Example 6 includes the apparatus of any of Examples 4 to 5, wherein the circuitry is further to access the data structure from one or more registers.

Example 7 includes the apparatus of any of Examples 1 to 6, wherein the circuitry is further to configure respective cache line sizes for the first and second regions of memory in accordance with the respective first and second protection levels.

Example 8 includes the apparatus of any of Examples 1 to 7, wherein the memory corresponds to an external memory subsystem.

Example 9 includes the apparatus of any of Examples 1 to 8, wherein the first protection level corresponds to a full chip-fail level of memory fault protection and wherein the second protection level corresponds to a bounded fault level of memory fault protection.

Example 10 includes the apparatus of any of Examples 1 to 9, wherein the memory is one of natively coupled to a processor and communicatively coupled to a processor via a cache-coherent interconnect.

Example 11 includes an electronic system, comprising memory, and a controller communicatively coupled to the memory, the controller including circuitry to control access to the memory for a range of addresses within a memory address space, and configure respective regions of the memory with respective non-overlapping sub-ranges of addresses within the memory address space to be accessed with a protection level of two or more memory fault protection levels respectively associated with the respective regions of the memory (e.g., where the respective memory regions correspond to a same memory type, such as DRAM).

Example 12 includes the system of Example 11, wherein the circuitry is further to reconfigure one or more of the respective regions of the memory at runtime in response to a request from a software agent.

Example 13 includes the system of any of Examples 11 to 12, wherein the circuitry is further to reconfigure one or more of the respective regions of the memory at runtime in response to a request from an operating system.

Example 14 includes the system of any of Examples 11 to 13, wherein the circuitry is further to determine a protection level associated with a region of the memory based on information to be stored in a data structure that is accessible to the controller.

Example 15 includes the system of Example 14, wherein the circuitry is further to access the data structure from one or more of registers and page tables to be stored in the memory.

Example 16 includes the system of any of Examples 11 to 15, wherein the circuitry is further to configure respective cache line sizes for the respective regions of memory in accordance with the respective associated protection levels.

Example 17 includes the system of any of Examples 11 to 16, wherein the memory corresponds to an external memory subsystem.

Example 18 includes the system of any of Examples 11 to 17, wherein a first protection level of the two or more memory fault protection levels corresponds to a full chip-fail level of memory fault protection and wherein a second protection level of the two or more memory fault protection levels corresponds to a bounded fault level of memory fault protection.

Example 19 includes the system of any of Examples 11 to 18, further comprising a processor natively coupled to the memory.

Example 20 includes the system of any of Examples 11 to 18, further comprising a processor communicatively coupled to the memory via a cache-coherent interconnect.

Example 21 includes a method, comprising controlling access to a memory for a range of addresses within a memory address space, and configuring respective regions of the memory with respective non-overlapping sub-ranges of addresses within the memory address space to be accessed with a protection level of two or more memory fault protection levels respectively associated with the respective regions of the memory (e.g., where the respective memory regions correspond to a same memory type, such as DRAM).

Example 22 includes the method of Example 21, further comprising reconfiguring one or more of the respective regions of the memory at runtime in response to a request from a software agent.

Example 23 includes the method of any of Examples 21 to 22, further comprising reconfiguring one or more of the respective regions of the memory at runtime in response to a request from an operating system.

Example 24 includes the method of any of Examples 21 to 23, further comprising determining a protection level associated with a region of the memory based on information stored in a data structure.

Example 25 includes the method of Example 24, further comprising reading the data structure from one or more page tables stored in the memory.

Example 26 includes the method of any of Examples 24 to 25, further comprising reading the data structure from one or more of registers.

Example 27 includes the method of any of Examples 21 to 26, further comprising configuring respective cache line sizes for the respective regions of memory in accordance with the respective associated protection levels.

Example 28 includes the method of any of Examples 21 to 27, wherein the memory corresponds to an external memory subsystem.

Example 29 includes the method of any of Examples 21 to 28, wherein a first protection level of the two or more memory fault protection levels corresponds to a full chip-fail level of memory fault protection and wherein a second protection level of the two or more memory fault protection levels corresponds to a bounded fault level of memory fault protection.

Example 30 includes the method of any of Examples 21 to 29, wherein the memory is one of natively coupled to a processor and communicatively coupled to a processor via a cache-coherent interconnect.

Example 31 includes an apparatus, comprising means for controlling access to a memory for a range of addresses within a memory address space, and means for configuring respective regions of the memory with respective non-overlapping sub-ranges of addresses within the memory address space to be accessed with a protection level of two or more memory fault protection levels respectively associated with the respective regions of the memory (e.g., where the respective memory regions correspond to a same memory type, such as DRAM).

Example 32 includes the apparatus of Example 31, further comprising means for reconfiguring one or more of the respective regions of the memory at runtime in response to a request from a software agent.

Example 33 includes the apparatus of any of Examples 31 to 32, further comprising means for reconfiguring one or more of the respective regions of the memory at runtime in response to a request from an operating system.

Example 34 includes the apparatus of any of Examples 31 to 33, further comprising means for determining a protection level associated with a region of the memory based on information stored in a data structure.

Example 35 includes the apparatus of Example 34, further comprising means for reading the data structure from one or more page tables stored in the memory.

Example 36 includes the apparatus of any of Examples 34 to 35, further comprising means for reading the data structure from one or more of registers.

Example 37 includes the apparatus of any of Examples 31 to 36, further comprising means for configuring respective cache line sizes for the respective regions of memory in accordance with the respective associated protection levels.

Example 38 includes the apparatus of any of Examples 31 to 37, wherein the memory corresponds to an external memory subsystem.

Example 39 includes the apparatus of any of Examples 31 to 38, wherein a first protection level of the two or more memory fault protection levels corresponds to a full chip-fail level of memory fault protection and wherein a second protection level of the two or more memory fault protection levels corresponds to a bounded fault level of memory fault protection.

Example 40 includes the apparatus of any of Examples 31 to 39, wherein the memory is one of natively coupled to a processor and communicatively coupled to a processor via a cache-coherent interconnect.

Example 41 includes at least one non-transitory one machine readable medium comprising a plurality of instructions that, in response to being executed on a computing device, cause the computing device to control access to a memory for a range of addresses within a memory address space, and configure respective regions of the memory with respective non-overlapping sub-ranges of addresses within the memory address space to be accessed with a protection level of two or more memory fault protection levels respectively associated with the respective regions of the memory (e.g., where the respective memory regions correspond to a same memory type, such as DRAM).

Example 42 includes the at least one non-transitory one machine readable medium of Example 41, comprising a plurality of further instructions that, in response to being executed on the computing device, cause the computing device to reconfigure one or more of the respective regions of the memory at runtime in response to a request from a software agent.

Example 43 includes the at least one non-transitory one machine readable medium of any of Examples 41 to 42, comprising a plurality of further instructions that, in response to being executed on the computing device, cause the computing device to reconfigure one or more of the respective regions of the memory at runtime in response to a request from an operating system.

Example 44 includes the at least one non-transitory one machine readable medium of any of Examples 41 to 43, comprising a plurality of further instructions that, in response to being executed on the computing device, cause the computing device to determine a protection level associated with a region of the memory based on information stored in a data structure.

Example 45 includes the at least one non-transitory one machine readable medium of

Example 44, comprising a plurality of further instructions that, in response to being executed on the computing device, cause the computing device to read the data structure from one or more page tables stored in the memory.

Example 46 includes the at least one non-transitory one machine readable medium of any of Examples 44 to 45, comprising a plurality of further instructions that, in response to being executed on the computing device, cause the computing device to read the data structure from one or more of registers.

Example 47 includes the at least one non-transitory one machine readable medium of any of Examples 41 to 46, comprising a plurality of further instructions that, in response to being executed on the computing device, cause the computing device to configure respective cache line sizes for the respective regions of memory in accordance with the respective associated protection levels.

Example 48 includes the at least one non-transitory one machine readable medium of any of Examples 41 to 47, wherein the memory corresponds to an external memory subsystem.

Example 49 includes the at least one non-transitory one machine readable medium of any of Examples 41 to 48, wherein a first protection level of the two or more memory fault protection levels corresponds to a full chip-fail level of memory fault protection and wherein a second protection level of the two or more memory fault protection levels corresponds to a bounded fault level of memory fault protection.

Example 50 includes the at least one non-transitory one machine readable medium of any of Examples 41 to 49, wherein the memory is one of natively coupled to a processor and communicatively coupled to a processor via a cache-coherent interconnect.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated.

As used in this application and in the claims, a list of items joined by the term “one or more of” may mean any combination of the listed terms. For example, the phrase “one or more of A, B, and C” and the phrase “one or more of A, B, or C” both may mean A; B; C; A and B; A and C; B and C; or A, B and C. Various components of the systems described herein may be implemented in software, firmware, and/or hardware and/or any combination thereof. For example, various components of the systems or devices discussed herein may be provided, at least in part, by hardware of a computing SoC such as may be found in a computing system such as, for example, a smart phone. Those skilled in the art may recognize that systems described herein may include additional components that have not been depicted in the corresponding figures. For example, the systems discussed herein may include additional components such as bit stream multiplexer or de-multiplexer modules and the like that have not been depicted in the interest of clarity.

While implementation of the example processes discussed herein may include the undertaking of all operations shown in the order illustrated, the present disclosure is not limited in this regard and, in various examples, implementation of the example processes herein may include only a subset of the operations shown, operations performed in a different order than illustrated, or additional operations.

In addition, any one or more of the operations discussed herein may be undertaken in response to instructions provided by one or more computer program products. Such program products may include signal bearing media providing instructions that, when executed by, for example, a processor, may provide the functionality described herein. The computer program products may be provided in any form of one or more machine-readable media. Thus, for example, a processor including one or more graphics processing unit(s) or processor core(s) may undertake one or more of the blocks of the example processes herein in response to program code and/or instructions or instruction sets conveyed to the processor by one or more machine-readable media. In general, a machine-readable medium may convey software in the form of program code and/or instructions or instruction sets that may cause any of the devices and/or systems described herein to implement at least portions of the operations discussed herein and/or any portions the devices, systems, or any module or component as discussed herein.

As used in any implementation described herein, the term “module” refers to any combination of software logic, firmware logic, hardware logic, and/or circuitry configured to provide the functionality described herein. The software may be embodied as a software package, code and/or instruction set or instructions, and “hardware”, as used in any implementation described herein, may include, for example, singly or in any combination, hardwired circuitry, programmable circuitry, state machine circuitry, fixed function circuitry, execution unit circuitry, and/or firmware that stores instructions executed by programmable circuitry. The modules may, collectively or individually, be embodied as circuitry that forms part of a larger system, for example, an integrated circuit (IC), system on-chip (SoC), and so forth.

Various examples may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one example may be implemented by representative instructions stored on a machine-readable medium which represents various logic within the processor, which when read by a machine causes the machine to fabricate logic to perform the techniques described herein. Such representations, known as IP cores may be stored on a tangible, machine readable medium and supplied to various customers or manufacturing facilities to load into the fabrication machines that actually make the logic or processor.

While certain features set forth herein have been described with reference to various implementations, this description is not intended to be construed in a limiting sense. Hence, various modifications of the implementations described herein, as well as other implementations, which are apparent to persons skilled in the art to which the present disclosure pertains are deemed to lie within the spirit and scope of the present disclosure.

It will be recognized that the examples are not limited to the examples so described, but can be practiced with modification and alteration without departing from the scope of the appended claims. For example, the above examples may include specific combination of features. However, the above examples are not limited in this regard and, in various implementations, the above examples may include the undertaking only a subset of such features, undertaking a different order of such features, undertaking a different combination of such features, and/or undertaking additional features than those features explicitly listed. The scope of the examples should, therefore, be determined with reference to the appended claims, along with the full scope of equivalents to which such claims are entitled.

What is claimed is:

1. An electronic apparatus, comprising:
one or more substrates; and
a controller coupled to the one or more substrates, the controller including circuitry to:
control access to a memory for a range of addresses within a memory address space,
configure a first region of the memory within a first sub-range of addresses within the memory address space to be accessed with a first protection level of two or more memory fault protection levels, and
configure a second region of the memory within a second sub-range of addresses within the memory address space that is non-overlapping with the first sub-range to be accessed with a second protection level of the two or more memory fault protection levels.

2. The apparatus of claim 1, wherein the circuitry is further to:
reconfigure one or more of the first and second regions of the memory with a different sub-range of addresses at runtime in response to a request from a software agent.

3. The apparatus of claim 1, wherein the circuitry is further to:
reconfigure one or more of the first and second regions of the memory with a different memory fault protection level at runtime in response to a request from a software agent.

4. The apparatus of claim 1, wherein the circuitry is further to:
determine respective protection levels associated with respective regions of the memory based on information to be stored in a data structure that is accessible to the controller.

5. The apparatus of claim 4, wherein the circuitry is further to:
access the data structure from one or more page tables to be stored in the memory.

6. The apparatus of claim 1, wherein the circuitry is further to:
interleave respective regions of the memory with respective memory fault protection levels.

7. The apparatus of claim 1, wherein the circuitry is further to:
configure respective cache line sizes for the first and second regions of memory in accordance with the respective first and second protection levels.

8. The apparatus of claim 1, wherein the first protection level corresponds to a full chip-fail level of memory fault protection and wherein the second protection level corresponds to a bounded fault level of memory fault protection.

9. An electronic system, comprising:
memory; and
a controller communicatively coupled to the memory, the controller including circuitry to:
control access to the memory for a range of addresses within a memory address space, and
configure respective regions of the memory with respective non-overlapping sub-ranges of addresses within the memory address space to be accessed with a protection level of two or more memory fault protection levels respectively associated with the respective regions of the memory.

10. The system of claim 9, wherein the circuitry is further to:
reconfigure one or more of the respective regions of the memory at runtime in response to a request from a software agent.

11. The system of claim 9, wherein the circuitry is further to:
determine a protection level associated with a region of the memory based on information to be stored in a data structure that is accessible to the controller.

12. The system of claim 11, wherein the circuitry is further to:
access the data structure from one or more registers.

13. The system of claim 9, wherein the circuitry is further to:
configure respective cache line sizes for the respective regions of memory in accordance with the respective associated protection levels.

14. The system of claim 9, wherein the memory corresponds to an external memory subsystem.

15. The system of claim 9, further comprising:
a processor communicatively coupled to the memory via a cache-coherent interconnect.

16. A method, comprising:
controlling access to a memory for a range of addresses within a memory address space; and
configuring respective regions of the memory with respective non-overlapping sub-ranges of addresses within the memory address space to be accessed with a protection level of two or more memory fault protection levels respectively associated with the respective regions of the memory.

17. The method of claim 16, further comprising:
reconfiguring one or more of the respective regions of the memory at runtime in response to a request from an operating system.

18. The method of claim 16, further comprising:
determining a protection level associated with a region of the memory based on information stored in a data structure.

19. The method of claim 18, further comprising:
reading the data structure from one or more page tables stored in the memory.

20. The method of claim 16, further comprising:
configuring respective cache line sizes for the respective regions of memory in accordance with the respective associated protection levels.
